(19) United States
(12) Patent Application Publication
(10) Pub. No.: US 2014/0165194 A1
(43) Pub. Date: Jun. 12, 2014

(54) Attack Protection Against XML Encryption Vulnerability

(71) Applicant: INTERNATIONAL BUSINESS MACHINES CORPORATION, Armonk, NY (US)

(72) Inventors: William Durward Dodd, Austin, TX (US); Chunlong Liang, Austin, TX (US); William J O'Donnell, Austin, TX (US); Eduardo N Spring, Austin, TX (US)

(73) Assignee: INTERNATIONAL BUSINESS MACHINES CORPORATION, Armonk, NY (US)

(21) Appl. No.: 13/706,691

(22) Filed: Dec. 6, 2012

(51) Int. Cl. G06F 21/55

(52) U.S. Cl. CPC G06F 21/55
USPC 726/23

(57) ABSTRACT

Protection against an attack which exploits an eXtensible Markup Language (XML) Encryption vulnerability includes receiving a ciphertext request utilizing an EncryptedKey element and detecting either a failure to decrypt the cipher value in the EncryptedData element or a failure to parse the resulting decrypted XML. Upon detecting the failure, a count of failures associated with the EncryptedKey element is incremented, and when the count exceeds a threshold number of failures, subsequent usage of the EncryptedKey element and delivery of the request to an application service are prevented. Optionally, a rejection message is returned to the requester.

### FIELD OF THE INVENTION

The invention generally relates to systems and methods for detecting and preventing successful ciphertext attacks, in particular within Simple Object Access Protocol (SOAP) computing environments.

### BACKGROUND OF INVENTION

The World Wide Web Consortium (W3C) eXtensible Markup Language (XML) Encryption standard is widely used to provide confidentiality protection of Simple Object Access Protocol (SOAP) Web Services as defined by the Web Services Security standards. This is applicable to both Java™ Application Programming Interface (API) for XML Web Services (JAX-WS), and for Java™ API for XML-based Remote Procedure Call (JAX-RPC) web services.

This allows “customers”, which are typically computers and networked devices, to exchange SOAP messages in an open and standard way. This interoperability standard calls for providing message based confidentiality protection using either Triple Data Encryption Algorithm (3DES or TDEA) or Advanced Encryption Standard (AES) in Cipher Block Chaining (CBC) mode.

CBC has some well-known weaknesses which are vulnerable to ciphertext attacks, especially for messages which are small in length. With a little effort, an attacker can craftily recover a plain text version of these encrypted messages. Depending on the sensitivity of the messages, this can lead to significant risk and confidential information exposures for customers and businesses.

For example, a clever attacker can exploit the weakness in CBC and decrypt an encrypted SOAP message by taking the following approach:
1. capture the original SOAP message with encrypted content;
2. manipulate the ciphertext (create 2 blocks of ciphertext: one IV block and one data block);
3. send the message to the endpoint with the manipulated ciphertext;
4. observe the result (success, failure in security handler, failure in application);
5. generate new ciphertext based on the success or failure result above; and
6. return to step (3) above.

Please note that Steps 2 and 5 are the tricky parts that require an understanding of the weakness in order to calculate the proper modified ciphertext. This approach results in a series of modified ciphertext messages that can eventually result in the attacker obtaining the plain text.

The ciphertext attack vulnerability is inherent in the CBC mode which is specified by the XML Encryption specification.

An application server environment may be challenged to provide protection against this type of vulnerability without compromise to the XML standards. Businesses require messages to be adequately protected from being compromised and businesses require SOAP messages to conform to the W3C

XML standard to maintain adequate interoperability.

### SUMMARY OF EXEMPLARY EMBODIMENTS OF THE INVENTION

Protection against an attack which exploits an eXtensible Markup Language (XML) Encryption vulnerability includes receiving a ciphertext request utilizing an EncryptedKey element and detecting either a failure to decrypt the cipher value in the EncryptedData element or a failure to parse the resulting decrypted XML. Upon detecting the failure, a count of failures associated with the EncryptedKey element is incremented, and when the count exceeds a threshold number of failures, subsequent usage of the EncryptedKey element and delivery of the request to an application service are prevented. Optionally, a rejection message is returned to the requester.

### BRIEF DESCRIPTION OF THE DRAWINGS

The description set forth herein is illustrated by the several drawings.

FIG. 1 provides an illustration of system components and interactions of a SOAP application server with enhancements according to the present invention.

FIGS. 2a and 2b illustrate an example SOAP XML envelope.

FIG. 3 depicts a generalized view of SOAP messaging between a client and a server.

FIG. 4 sets forth a logical process according to the present invention.

FIG. 5 sets forth a generalized architecture of computing platforms suitable for at least one embodiment of the present and the related inventions.

### DETAILED DESCRIPTION OF EXEMPLARY EMBODIMENT(S) OF THE INVENTION

The inventors of the present and the related invention have recognized problems not yet recognized by those skilled in the relevant arts, as described in the following paragraphs and review of the available state of the existing art.

As of the preparation of this patent application, the most current W3C recommendation for encryption and syntax processing is version 1.1, published on Mar. 3, 2011. A very good description of the Ciphertext attack can be found in a research paper by Tibor Jager of Rhur University, Bochom, entitled “Character Encoding Pattern Attacks—How to break XML Encryption.”

One currently-available attempt to fix this vulnerability is to unify error messages generated by the web service to prevent a third party from determining if failure occurred in the security handler or application. The present inventors, however, have determined that a drawback to this solution is that the SOAP specifications dictate certain Fault codes to be generated in certain conditions, therefore this solution is not fully compliant with the W3C recommendation.

Another currently-available attempt to solve this vulnerability is to use newer algorithms and protocols which are not susceptible to this particular form of attack. The present inventors have determined that a drawback with this approach is that the new algorithms are not yet part of the XML Encryption specification, and thus this solution also leads to non-compliant implementations.

Still another approach currently in the art is to digitally sign the encrypted data so that signature validation will immediately reject messages where the ciphertext has been manipulated. The present inventors have realized a drawback with this solution is that this signing approach is not the common or best-practices approach, so most web services deployed would not be using this approach.

Having found no solutions to this problem which maintain full compatibility with the W3C recommendations, the present disclosure will outline a new method which enables a run-time application server environment to provide protection against ciphertext attack described above while complying with the W3C XML Encryption standard with SOAP messages using a security run-time environment by integrating a detection layer into the run-time server to detect and reject requests that match the characteristics of the ciphertext attack. If the application server detects this ciphertext attack, it simply rejects the request. Embodiments of the present invention may also be useful in protecting other web services which are using alternate web service protocols, especially those which use XML encryption, such as Secure Assertion Markup Language (SAML) version 2.0, and potentially to other systems which utilize encryption with a Cipher Block Chaining (CBC) mode.

Exemplary embodiments according to the present invention described herein provide an enhancement to SOAP application servers to provide protection against ciphertext attack described above when using an encryption process such as that set forth in the W3C XML Encryption standard with SOAP messages. It will be readily recognized that other embodiments of the invention may be provided to environments using other web service protocols.

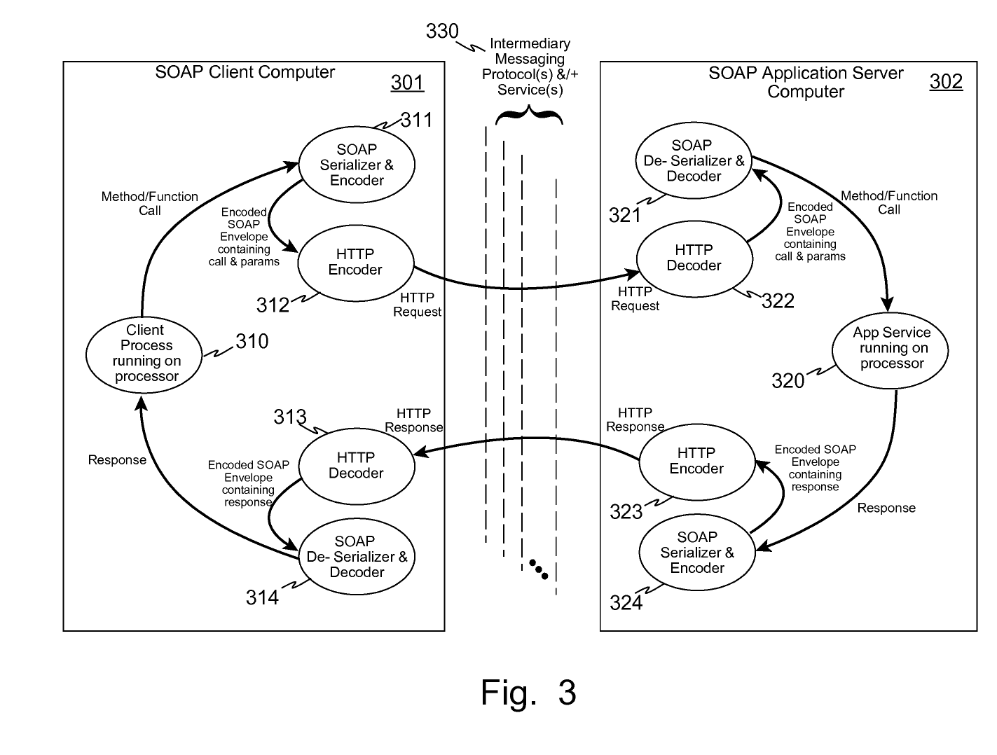

Referring now to FIG. 3, a generalization of a set of computing components in a SOAP environment is shown. A SOAP client computer (301), running programs on a processor, may request certain application services from a SOAP application server computer (302), which is also running one or more computer programs on a processor.

A client process (310) performs a method call or function call which is received by a SOAP serializer and encoded (311) to produce a SOAP envelope. This envelope is then handled by a Hypertext Transfer Protocol (HTTP) encoder (312). The HTTP-encoded request is then transmitted via one or more messaging protocols, services, and/or networks (330) to the SOAP application server computer (302).

Responsive to receiving the HTTP request, an HTTP decoder (322) produces the SOAP envelope, which is then decoded (321), and if there are no failures, the method or function call is passed on to one or more application services (320). The application services (320) then provide one or more responses to a SOAP envelope encoder (324), which outputs a response envelope to an HTTP encoder (323). The HTTP-encoded response is then transmitted (330) to the SOAP client computer (301).

Upon receipt of the response, the SOAP client computer (301) decodes the HTTP response, and decodes the SOAP envelope, returning the response to the client process (310).

According to this present invention, a detection layer is integrated into an application server, such as into a SOAP web server, to detect and reject during run-time SOAP XML requests that match the characteristics of the ciphertext attack described above. If the run-time detects this ciphertext attack, it simply rejects the request.

Run-time servers can integrate a detection capability in blocking this ciphertext attack. The process embodies that, if the run-time detects a ciphertext attack in progress, it properly defends itself and reject the request, thereby blocking the ability for any message content to be decrypted or used by an application instance. There are multiple aspects of the request that can be observed and used as part of this detection. The primary items to observe in order to detect the attack consist of:
1. a request containing exactly a pre-determined number of blocks of ciphertext, such as exactly 2 blocks of ciphertext; and
2. (a) the request fails due to a decryption or XML parsing error; or
   (b) that a particular message (the particular block of the ciphertext) is using the same encryption key (EncryptedKey element) as a previous message or messages that had failures in the decryption or XML parsing.

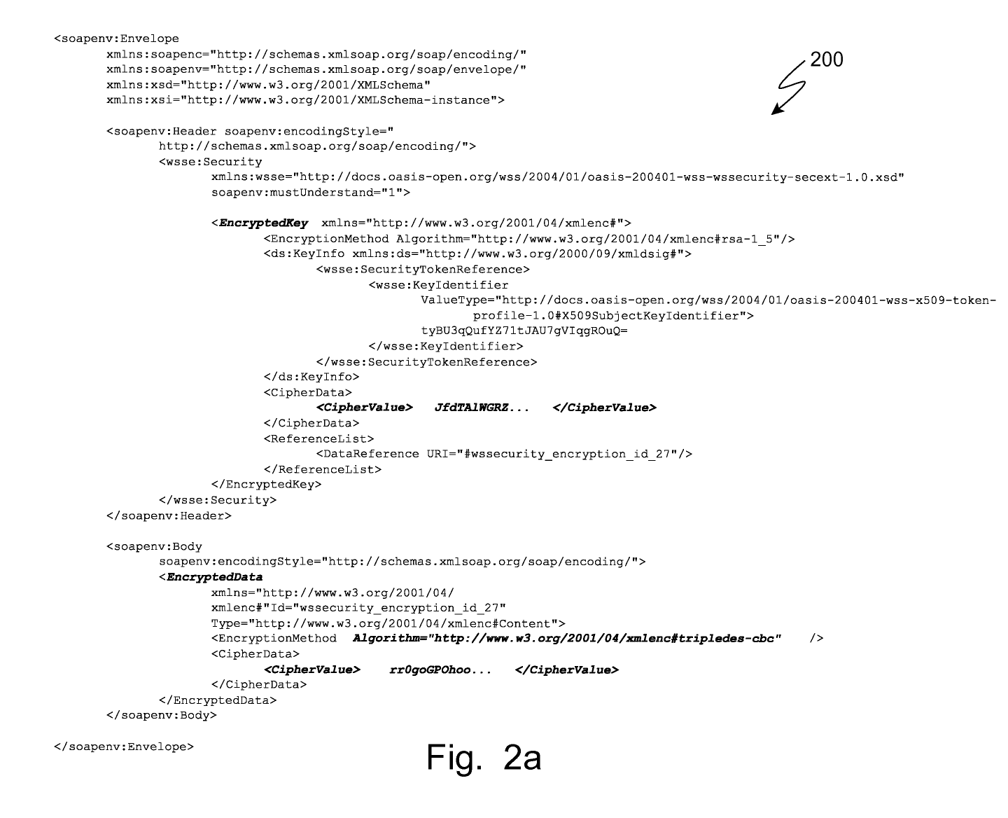

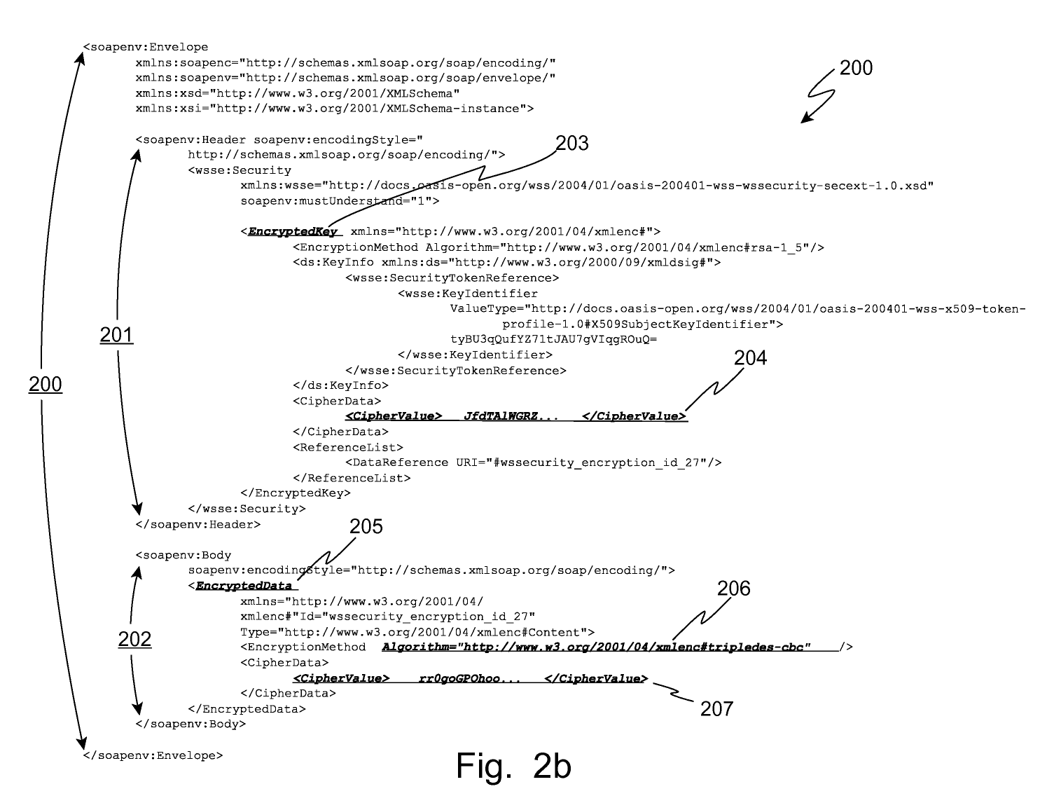

Detection of the first and second conditions can be illustrated using a SOAP message example as shown in FIGS. 2a and 2b. For the reader's convenience, an un-annotated example SOAP XML envelope is shown (200) in FIG. 2a. FIG. 2b includes annotation of the example XML envelope (200) for reference within the present disclosure. A typical envelope will have a header element (201) and a body element (202). In this example SOAP message below, the encryption key (203, 204) being used is shown (203, 204) in italics and underline. The actual key value is quite long when expressed in alphanumeric text, so for brevity of the diagram, an ellipsis is shown in the cipher value.

The elements in the message ciphertext that may be under attack (205, 206, and 207) are also shown in italics and underline. The CipherValue element (207) will be exactly a pre-determined number of blocks long in the attack scenario, such as exactly 2 blocks long. The logical process according to the present invention determines how long a block is and whether it is a pre-determined length of interest. For each of these failed requests, the logical process stores a counter associated with the EncyptedKey. One such data structure to implement this counter is a hashtable with a key of the EncryptedKey and a value of the counter. The hashtable value is a counter which is incremented each time an entry is stored with the same key. Responsive to the counter reaching a certain threshold, the logical process will immediately reject the request.

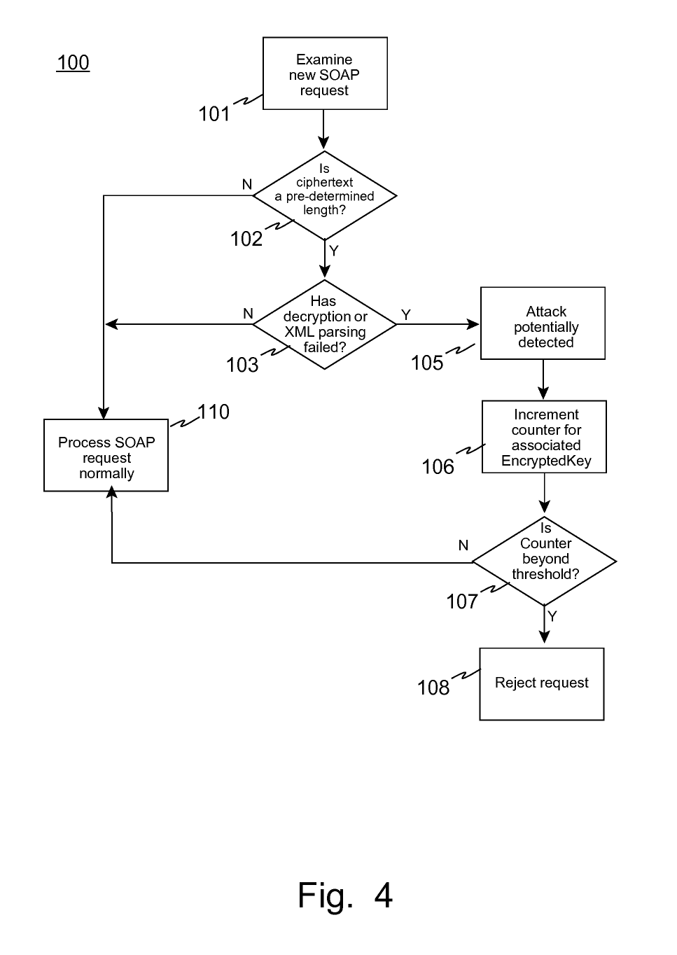

Such a logical process (100) is illustrated in FIG. 4, in which a new SOAP request (101) is examined, and if the ciphertext is two blocks long (102), if XML parsing or decryption of the SOAP message has failed (103), then a potential attack has been detected (105).

Responsive to this detection, the counter associated with the EncryptedKey of the request is incremented (106), and if the counter exceeds a pre-determined threshold, then the SOAP request is rejected. Otherwise, searching for potential attacks is resumed, and the current SOAP request is handled normally (110).

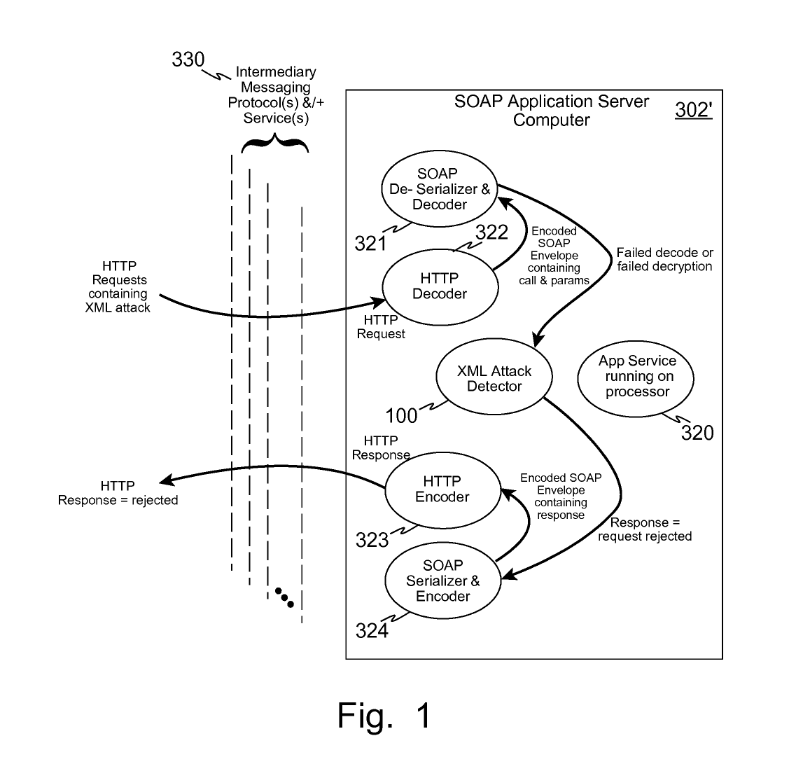

FIG. 1 shows a modified system arrangement (302′), similar to that of FIG. 3 except that it incorporates the detector (100) logical process being executed by a processor on a SOAP application server computer or computing platform. As show in this diagram, and relative to the descriptions of FIGS. 3 and 4, failed requests are intercepted by the detector (100) and are prevented from being delivered to or accessed by any application services, such that a rejection to the request is provided to the SOAP initiator instead of an application service response.

Suitable Computing Platform. The preceding paragraphs have set forth example logical processes according to the present invention, which, when coupled with processing hardware, embody systems according to the present invention, and which, when coupled with tangible, computer readable memory devices, embody computer program products according to the related invention.

Regarding computers for executing the logical processes set forth herein, it will be readily recognized by those skilled in the art that a variety of computers are suitable and will become suitable as memory, processing, and communications capacities of computers and portable devices increases. In such embodiments, the operative invention includes the combination of the programmable computing platform and the programs together. In other embodiments, some or all of the logical processes may be committed to dedicated or specialized electronic circuitry, such as Application Specific Integrated Circuits or programmable logic devices.

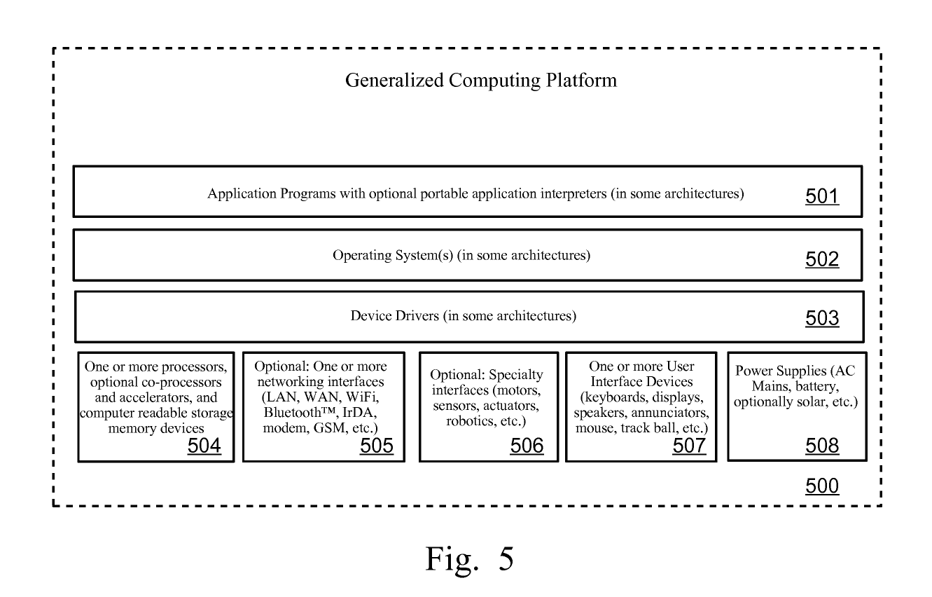

The present invention may be realized for many different processors used in many different computing platforms, such as an IBM WebSphere Application Server (WAS). FIG. 5 illustrates a generalized computing platform (500), such as common and well-known computing platforms such as “Personal Computers”, web servers such as an IBM iSeries™ server, and portable devices such as personal digital assistants and smart phones, running a popular operating systems (502) such as Microsoft™ Windows™ or IBM™ AIX™, Palm OS™, Microsoft Windows Mobile™, UNIX, LINUX, Google Android™, Apple iPhone iOS™, and others, may be employed to execute one or more application programs to accomplish the computerized methods described herein. Whereas these computing platforms and operating systems are well known an openly described in any number of textbooks, websites, and public “open” specifications and recommendations, diagrams and further details of these computing systems in general (without the customized logical processes of the present invention) are readily available to those ordinarily skilled in the art.

Many such computing platforms, but not all, allow for the addition of or installation of application programs (501) which provide specific logical functionality and which allow the computing platform to be specialized in certain manners to perform certain jobs, thus rendering the computing platform into a specialized machine. In some “closed” architectures, this functionality is provided by the manufacturer and may not be modifiable by the end-user.

The “hardware” portion of a computing platform typically includes one or more processors (504) accompanied by, sometimes, specialized co-processors or accelerators, such as graphics accelerators, and by suitable computer readable memory devices (RAM, ROM, disk drives, removable memory cards, etc.). Depending on the computing platform, one or more network interfaces (505) may be provided, as well as specialty interfaces for specific applications. If the computing platform is intended to interact with human users, it is provided with one or more user interface devices (507), such as display(s), keyboards, pointing devices, speakers, etc. And, each computing platform requires one or more power supplies (battery, AC mains, solar, etc.).

Conclusion. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It should also be recognized by those skilled in the art that certain embodiments utilizing a microprocessor executing a logical process may also be realized through customized electronic circuitry performing the same logical process(es).

It will be readily recognized by those skilled in the art that the foregoing example embodiments do not define the extent or scope of the present invention, but instead are provided as illustrations of how to make and use at least one embodiment of the invention. The following claims define the extent and scope of at least one invention disclosed herein.

What is claimed is:

1. A method to protect against an attack exploiting an XML Encryption vulnerability comprising:
receiving by a application services server computer a ciphertext request utilizing an EncryptedKey element, wherein the remote application services server computer comprises a processor;
responsive to the ciphertext request containing exactly a pre-determined number of blocks of ciphertext, and responsive to the request having failed due to a decryption or XML parsing error and that a block of the ciphertext is using the same encryption key (EncryptedKey element) as a previous message that had failures in the decryption or XML parsing, incrementing by the application services server computer a count of failures associated with the EncryptedKey element; and
responsive to the count exceeding a threshold number of failures, performing by the application services server computer a protective action against an attack.

2. The method set set forth in claim 1 wherein the protective action comprises one or more actions selected from the group consisting of returning a rejection message to a requester process associated with the request, preventing usage of the EncryptedKey element, and preventing delivery of the request to an application service.

3. The method as set forth in claim 1 wherein the detected failure comprises a markup language parsing error.

4. The method as set forth in claim 1 wherein the received request is compliant with a W3C XML Encryption standard for exchanging Simple Object Access Protocol (SOAP) messages utilizing a triple Data Encryption Algorithm (3DES) encryption standard in Cipher Block Chaining (CBC) mode.

5. The method as set forth in claim 1 wherein the received request is compliant with a W3C XML Encryption standard for exchanging Simple Object Access Protocol (SOAP) messages utilizing Advanced Encryption Standard (AES) in Cipher Block Chaining (CBC) mode.

6. A computer program product to protect against an attack exploiting an XML Encryption vulnerability comprising:
a tangible, computer-readable storage memory device;
first program code for receiving by a remote application services server computer a ciphertext request utilizing an EncryptedKey element;
second program code for, responsive to the ciphertext request containing exactly a pre-determined number of blocks of ciphertext, and the request having failed due to a decryption or XML parsing error and that a block of the ciphertext is using the same encryption key (EncryptedKey element) as a previous message that had failures in the decryption or XML parsing, incrementing by the application services server computer a count of failures associated with the EncryptedKey element; and
third program code for, responsive to the count exceeding a threshold number of failures, performing a preventative action;
wherein the first, second and third program codes are stored by the tangible, computer-readable storage memory device.

7. The computer program product as set forth in claim 6 wherein the third program code is for performing at least one preventative action selected from the group consisting of returning a rejection message to a requester process associated with the request, preventing usage of the EncryptedKey element by an application service, and preventing delivery of the request to an application service.

8. The computer program product as set forth in claim 6 wherein the detected failure comprises a markup language parsing error.

9. The computer program product as set forth in claim 6 wherein the received request is compliant with a W3C XML Encryption standard for exchanging Simple Object Access Protocol (SOAP) messages utilizing a triple Data Encryption Algorithm (3DES) encryption standard in Cipher Block Chaining (CBC) mode.

10. The computer program product as set forth in claim 6 wherein the received request is compliant with a W3C XML Encryption standard for exchanging Simple Object Access Protocol (SOAP) messages utilizing Advanced Encryption Standard (AES) in Cipher Block Chaining (CBC) mode.

11. A system to protect against an attack exploiting an XML Encryption vulnerability comprising:
a request receiver portion of an application services server computer for receiving a ciphertext request utilizing an EncryptedKey element, wherein the application services server computer comprises a processor;
an attack detector portion of the application services server for, responsive to the ciphertext request containing exactly a pre-determined number of blocks of ciphertext, the request having failed due to a decryption or XML parsing error and that a block of the ciphertext is using the same encryption key (EncryptedKey element) as a previous message that had failures in the decryption or XML parsing, incrementing by the application services server computer a count of failures associated with the EncryptedKey element; and
a rejector portion of the application services server computer for, responsive to the count exceeding a threshold number of failures, performing a preventative action.

12. The system as set forth in claim 11 wherein the rejector portion is for performing at least one preventative action selected from the group consisting of returning a rejection message to a requester process associated with the request, preventing usage of the EncryptedKey element by an application service, and preventing delivery of the request to an application service.

13. The system as set forth in claim 11 wherein the detected failure comprises a markup language parsing error.

14. The system as set forth in claim 11 wherein the received request is compliant with a W3C XML Encryption standard for exchanging Simple Object Access Protocol (SOAP) messages utilizing a triple Data Encryption Algorithm (3DES) encryption standard in Cipher Block Chaining (CBC) mode.

15. The system as set forth in claim 11 wherein the received request is compliant with a W3C XML Encryption standard for exchanging Simple Object Access Protocol (SOAP) messages utilizing Advanced Encryption Standard (AES) in Cipher Block Chaining (CBC) mode.
